(19) United States
(12) Patent Application Publication
(10) Pub. No.: US 2018/0186422 A1
(43) Pub. Date: Jul. 5, 2018

(54) MOTORCYCLE SEAT COVER SYSTEM

(71) Applicant: Gene Howells, Peckville, PA (US)

(72) Inventor: Gene Howells, Peckville, PA (US)

(21) Appl. No.: 15/399,051

(22) Filed: Jan. 5, 2017

(51) Int. Cl. B62J 19/00

(52) U.S. Cl. CPC B62J 19/00

(57) ABSTRACT

A motorcycle seat cover system that includes: a cover adapted to cover a motorcycle seat; a seat insert; and a rear extension, wherein the rear extension extends beyond a rear portion of the motorcycle seat. The cover is made of a flexible material and a storage compartment within the motorcycle seat adapted to store the cover during non-use.

### BACKGROUND OF THE INVENTION

### Field of Invention

The present invention relates to a seat cover system adapted for use on a motorcycle.

### Description of Related Art

A motorcycle normally includes a seat that is exposed to weather conditions when parked. Motorcyclists normally require use of a helmet and a leather jacket. If a rider is also riding the bike then an additional helmet and leather jacket may be part of the gear that's used and needed for motorcycle operation. Normally, this gear is left on the motorcycle in the saddlebags or other storage compartments near or associated with the seat. As a result, the gear along with the seat and saddlebags are exposed to weather conditions and further may be susceptible to theft. It would be advantageous to have a lockable seat cover for both the seat and any accessory compartment such as saddlebags. The cover's lock provides a means to secure the gear and saddlebags while the operator is away from the motorcycle. This cover provides protection for the seat and security for the riding gear.

### SUMMARY OF THE INVENTION

The present invention relates to a motorcycle seat cover system that includes: a cover adapted to cover a motorcycle seat; a seat insert; and a rear extension, wherein the rear extension extends beyond a rear portion of the motorcycle seat. The cover is made of a flexible material and a storage compartment within the motorcycle seat adapted to store the cover during non-use.

### BRIEF DESCRIPTION OF DRAWINGS

FIG. 1 depicts a side view of a seat cover system in accordance with the present invention.

FIG. 2 depicts the seat cover folded within a storage compartment in accordance with the present invention.

### DETAILED DESCRIPTION

The present invention relates to motorcycle seat cover and security system that covers and secures a seat and gear. The cover system according to the present invention that includes a cover that wraps and secures the seat and accessory gear. An insert is provided at the seat level and extends rearward over the seat and over any cargo compartments that may be extending from or attached to the seat. Once completely covered the cover includes a steel wire system that tightens and secures the cover in place with a means to lock the steel cable to avoid removal of the cover. As a result, the cover provides both a shield for weather conditions and secures the contents of any saddlebags or other storage compartments associated with the motorcycle near the seat area.

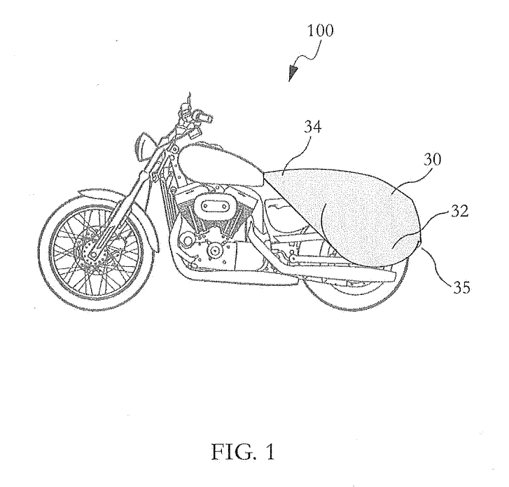

In reference to FIG. 1, a side view of a Motorcycle Seat Cover System 100 is depicted. The motorcycle seat cover system 100 includes a seat insert 34 and a cover 30 that extends across a seat of a motorcycle as shown in FIG. 1. The cover 30 further extends to the rear of the motorcycle covering a back side of the seat and any associated saddlebags or other storage compartments. An extended portion 32 extends over saddlebags at the rear of the motorcycle. The cover 30 as shown in FIG. 1 it extends downward below the rear portion of the seat and any rear fenders that also may be associated with the motorcycle. Once in place a steel wire within the cover 30 may be tightened and then locked with a lock 35 to secure the cover 30 onto the seat and to prevent removal of the cover, therefore protect any items stored under the cover.

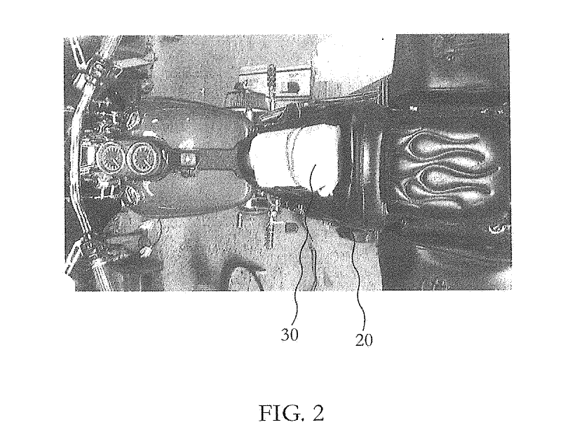

FIG. 2 depicts the cover 30 within a storage compartment 20 of the seat of a motorcycle. The cover 30 is made of flexible material thus allowing the user to easily fold and store the cover as shown in FIG. 2. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A motorcycle seat cover system compromising:
a cover adapted to cover a motorcycle seat;
a seat insert; and
a rear extension, wherein the rear extension extends beyond a rear portion of the motorcycle seat.

2. The motorcycle seat cover system according to claim 1, where the cover is made of a flexible material.

3. The motorcycle seat cover according to claim 1, where a storage compartment within the motorcycle seat adapted to store the cover during non-use.

4. The motorcycle seat cover according to claim 1, further including a lock to secure the cover in place.
